(19) United States
(12) Patent Application Publication
(10) Pub. No.: US 2004/0005907 A1
(43) Pub. Date: Jan. 8, 2004

(54) Method and apparatus for transmit power adjustment in radio frequency systems

(76) Inventors: Long-Wen Tain, Hsinchu (TW); Tsung-Liang Lin, Hsinchu (TW); Jan-Kwo Leeng, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/614,281

(22) Filed: Jul. 7, 2003

Related U.S. Application Data
(63) Continuation-in-part of application No. 10/062,116, filed on Jan. 30, 2002.

(51) Int. Cl. H04B 1/38; H04B 7/00

(52) U.S. Cl. 455/522; 455/73

(57) ABSTRACT

A method and apparatus for transmit power adjustment in radio frequency systems. According to the invention, the apparatus is made up of a detector, an input module and an output module. The detector is adapted to detect the output power of a transmit channel. The input module coupled to the detector generates an input value substantially indicative of the output power while the output module accepts an output value that is used to adjust the output power. Also, there is a means for computing the output value based on a difference multiplied by a predetermined factor, where the difference is between the input value and a target value substantially corresponding to the desired output power.

### BACKGROUND OF THE INVENTION

1. Field of the Invention

The invention relates to radio frequency (RF) systems, and more particularly to a mechanism of transmit power adjustment for a wireless local area network (WLAN) device.

2. Description of the Related Art

A wireless local area network (WLAN) is a flexible data communications system that can either replace or extend a wired LAN to provide added functionality. Using radio frequency (RF) technology, WLANs transmit and receive data over the air, through walls, ceilings and even cement structures, without wired cabling. A WLAN provides all the features and benefits of traditional LAN technologies like Ethernet and Token Ring, but without the limitations of being tethered to a cable. This provides greatly increased freedom and flexibility.

The most common WLANs currently are those conforming to the IEEE 802.11b standard. Not only are they increasingly deployed in private enterprise applications, but also in public applications such as airports and coffee shops. 802.11b WLANs are designed to operate in the 2.4 GHz Industrial, Scientific and Medical (ISM) band. The IEEE 802.11b standard divides the assigned RF spectrum into 14 channels. Because the 2.4 GHz ISM band is unlicensed, reasonably wide, and almost globally available, it constitutes a popular frequency band suitable to low cost radio solutions such as Bluetooth devices and cordless telephones. When using a shared resource like the 2.4 GHz ISM band, it is important to not use more of the resource than is actually required. This can be thought of as a golden rule for using unlicensed bands. For example, if two devices in the band can communicate by transmitting at a power level of 4 dBm, it is an over usage of the band to transmit at 20 dBm. By transmitting too much power in the band, the overall capacity per area is reduced and the transmission of other users of the band may be needlessly interfered with.

In the USA, the FCC limits the maximum allowable output power of an 802.11b system to 1 watt. Within the operational frequency band, a conformant transmitter is required to pass a spectrum mask test. FIG. 1 illustrates the transmit spectrum mask defined in the IEEE 802.11b standard. In FIG. 1, the solid line labeled by 100 represents the transmit spectrum mask while the curve label by 110 represents an unfiltered signal sin x/x . As shown, the transmitted spectral products must be less than −30 dBr (dB relative to the sin x/x peak) for

f_{c}−22 MHz<f<f_{c}−11 MHz; and

f_{c}+11 MHz<f<f_{c}+22 MHz;

and must be less than −50 dBr for

f<f_{c}−22 MHz; and

f>f_{c}+22 MHz.

where

f_{c} is the channel center frequency.

Therefore, all conformant IEEE 802.11b equipment must be well adjusted before shipping such that their output power can thereby meet the above requirements. Typically, prior arts set up a measuring arrangement including the device under test (DUT), a host computer, spectrum analyzer, and power meter and conducted a tedious procedure to manually adjust the output power of the DUT. Due to a large variation in the transmit gain, the prior arts may require excessive time to appropriately tune the 802.11b equipment in this manner. There are 14 channels that must be adjusted, thus the prior-art manual procedure is too complicated and time consuming. Accordingly, what is needed is an efficient scheme for automatic transmit power adjustment in 802.11b systems.

### SUMMARY OF THE INVENTION

It is an object of the present invention to provide a mechanism of transmit power adjustment for WLAN equipment.

The present invention is generally directed to a method and apparatus for transmit power adjustment in radio frequency systems. According to one aspect of the invention, the first step of the method is to detect the output power of a transmit channel. Then, an input value substantially indicative of the output power is generated. Based on a difference multiplied by a predetermined factor, an output value is computed accordingly, where the difference is between the input value and a target value substantially corresponding to the desired output power of the transmit channel. As a result, the output power is adjusted for the transmit channel according to the output value.

According to another aspect of the invention, the output power of a transmit channel is detected first. Next, an input value substantially indicative of the output power is generated. The input value is checked to determine if it falls within a desired range. If not, an output value is computed based on a difference multiplied by a predetermined factor, where the difference is between the input value and a target value substantially corresponding to the desired output power of the transmit channel. In particular, the predetermined factor is defined as the ratio between a first slope of the output value versus the output power and a second slope of the input value versus the output power. Thus, the output power is adjusted for the transmit channel according to the output value. The above steps are repeated until the input value is within the desired range.

In a preferred embodiment of the invention, an apparatus for transmit power adjustment in radio frequency systems is disclosed. The apparatus of the invention includes a detector, an input module and an output module. The detector is adapted to detect the output power of a transmit channel. The input module coupled to the detector is capable of generating an input value substantially indicative of the output power. The output module accepts an output value that is used to adjust the output power. Also, there is a means for computing the output value based on a difference multiplied by a predetermined factor, where the difference is between the input value and a target value corresponding to the desired output power.

### DESCRIPTION OF THE DRAWINGS

The present invention will be described by way of exemplary embodiments, but not limitations, illustrated in the accompanying drawings in which like references denote similar elements, and in which:

FIG. 1 is the transmit spectrum mask according to the IEEE 802.11b standard;

FIG. 2 is a functional block diagram illustrating a preferred embodiment according to the invention;

FIG. 3 is a graph illustrating the input value vs. the output power according to the invention;

FIG. 4 is a graph illustrating the output value vs. the output power according to the invention; and

FIG. 5 is a flowchart illustrating primary steps for transmit power adjustment according to the invention.

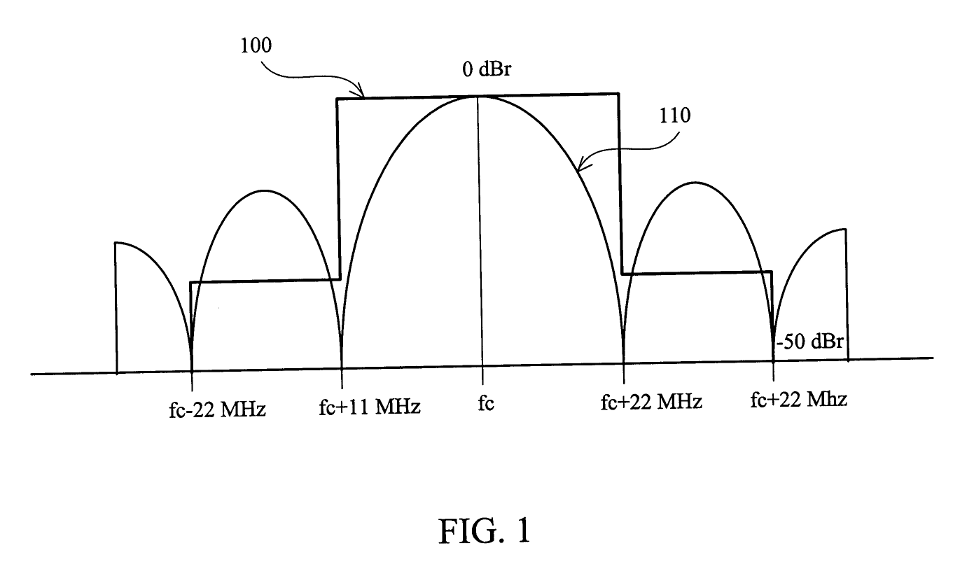

### DETAILED DESCRIPTION OF THE INVENTION

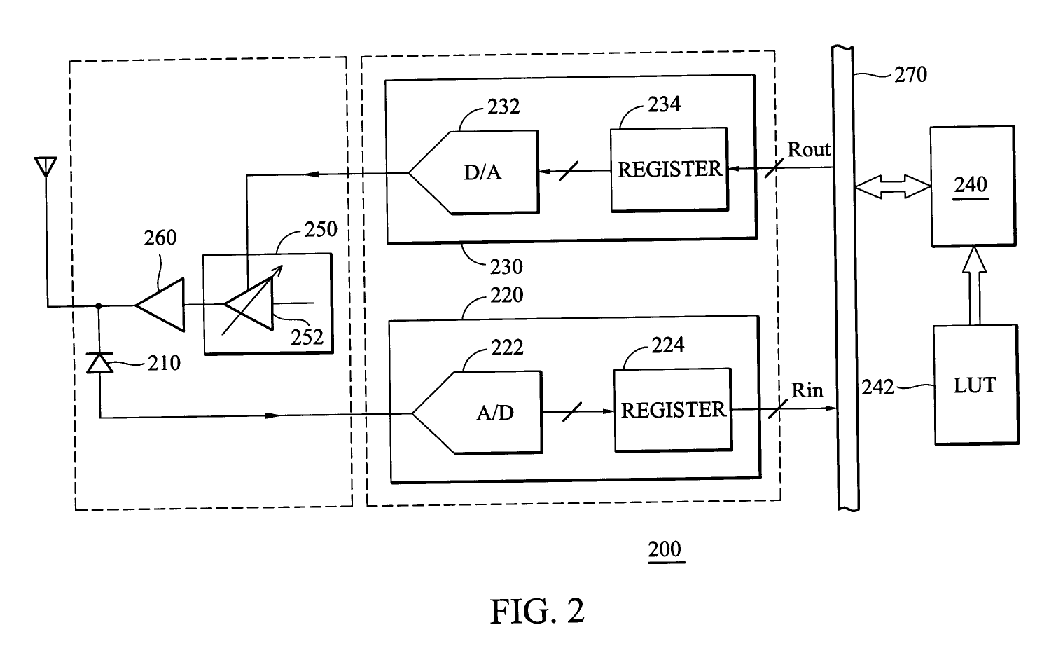

Referring to FIG. 2, an apparatus of transmit power adjustment that realizes the invention in RF systems is illustrated. As an example, the RF systems are, but not limited to, computers with WLAN adapters. In this case, the device under test and adjustment is directed to a WLAN adapter. In FIG. 2, the apparatus 200 is essentially constituted by a detector 210, an input module 220, an output module 230 and a computing means 240. Briefly, the detector 210 is provided to detect the output power of a kth transmit channel being adjusted. The input module 220 coupled to the detector 210 is capable of generating an input value Rᵢₙ substantially indicative of the output power. The output module 230 accepts an output value Rₒᵤₜ from the computing means 240 in which the output value Rₒᵤₜ is used to adjust the output power. Specifically, the computing means 240 is configured for computing the output value Rₒᵤₜ based on a predetermined factor λₖ, the input value, Rᵢₙ and a target value \hat{R}ᵢₙ corresponding to the desired output power.

Taking a WLAN adapter conforming to 802.11b as an example, the input and the output modules 220, 230 are implemented in the baseband portion of the WLAN adapter. Moreover, there are a transceiver 250 and a power amplifier 260 in the RF portion of the WLAN adapter. As shown in FIG. 2, the input and the output modules 220, 230 both communicate with the computing means 240 through a bus interface 270 such as PCMCIA, Cardbus, PCI, USB, and the like. The transceiver 250 which includes a variable gain amplifier 252 responsive to the output value is coupled between the power amplifier 260 and the output module 230. The detector 210 is coupled to the output of the power amplifier 260. Consequently, the adapter's output power emitted from the power amplifier 260 is detected by the detector 210 and fed to the input module 220. The input module 220 comprises an A/D converter 222 and a register 224 while the output module 230 comprises a D/A converter 232 and another register 234. The detected output power is converted to digital form through the A/D converter 222 and then recorded in the register 224 in terms of the input value Rᵢₙ. The input value Rᵢₙ is sent to the computing means 240 where the output value Rₒᵤₜ is calculated by multiplying the difference between the input value Rᵢₙ and the target value \hat{R}ᵢₙ by the predetermined factor λₖ. After that, the output value Rₒᵤₜ is written into the register 234 and subjected to a digital-to-analog conversion by the D/A converter 232 before applying to the variable gain amplifier 252. In response to an analog voltage converted from Rₒᵤₜ, the variable gain amplifier 252 alters its output thereby adjusting the output power for the kth transmit channel.

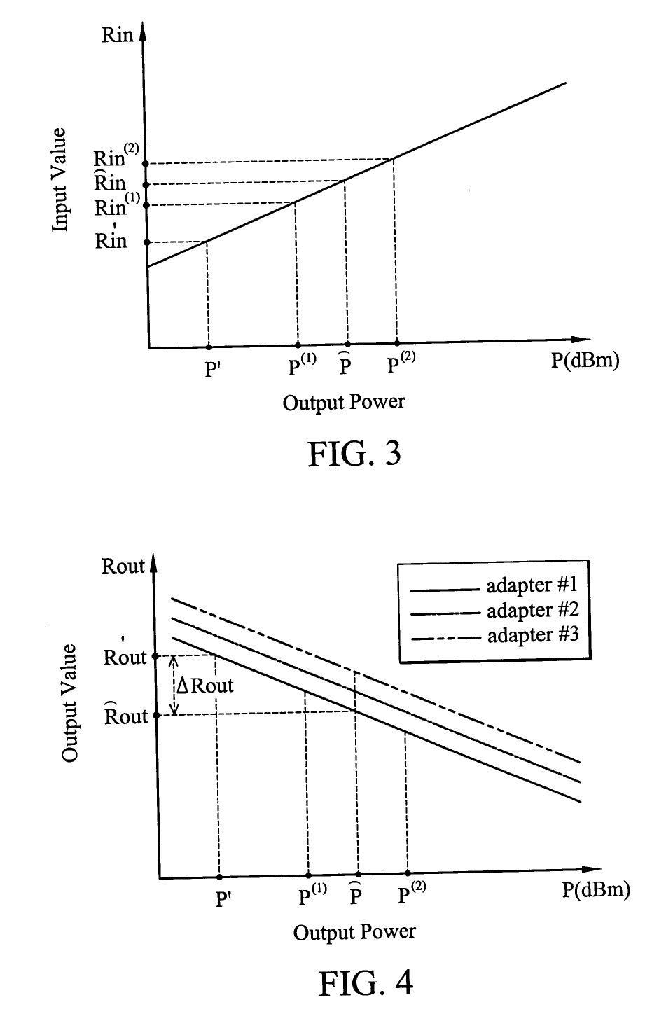

The features of the invention will be more clearly understood from the following description in conjunction with FIGS. 3 and 4. It should be noted that the output power herein is plotted in logarithmic scale. For example, the output power is expressed in dBm as shown in FIGS. 3 and 4. In order to find the relationship among the input vale Rᵢₙ, the output value, Rₒᵤₜ and the output power of each transmit channel, an experiment is conducted with a large enough sample of the invention. Regarding the experimental result, it can be seen that the input value Rᵢₙ varies substantially linearly with the output power detected by the detector 210. Without loss of generality, the relationship between input vale Rᵢₙ and the output power of the kth transmit channel can be approximated by one straight line with a slope ρ_{in,k} as shown in FIG. 3. Although the output power varies substantially linearly with the output value Rₒᵤₜ, the relationship between output value Rₒᵤₜ and the output power is different from adapter to adapter. Fortunately, the output value vs. output power curves have almost the same slope for a batch of WLAN adapters. For example, the relationship between output value Rₒᵤₜ and the output power of the kth transmit channel for three adapters can be represented by three straight lines with the same slope ρ_{out,k} as shown in FIG. 4. The subscript k herein refers to the kth transmit channel.

Referring to FIGS. 3 and 4, it is shown that the desired output power is limited within P⁽¹⁾ and P⁽²⁾ and a central point of the desired power range is denoted by \hat{P} The input value ranges between

$${R}_{i n}^{( 1 )} and {R}_{i n}^{( 2 )}$$

which correspond to the upper, the lower limits P⁽¹⁾ and P⁽²⁾, respectively. The target value \hat{R}ᵢₙ corresponding to \hat{P} is actually the central point of the input range. On the other hand, \hat{R}ₒᵤₜ represents an output value corresponding to \hat{P}. Note that \hat{R}ₒᵤₜ is different from adapter to adapter. Now assuming that the currently detected output power is P′, the corresponding input and output values are

$${{R}^{′}}_{i n} and {{R}^{′}}_{out} ,$$

respectively, the difference between \hat{R}ᵢₙ and

$${{R}^{′}}_{i n}$$

can be expressed in terms of ρ_{in,k}:

$${{R}^{̑}}_{i n} - {{R}^{′}}_{i n} = {ρ}_{i n , k} \cdot ( {P}^{̑} - {P}^{′} ) \qquad ( 1 )$$

This can be rewritten as:

$${P}^{̑} - {P}^{′} = \frac{{{R}^{̑}}_{i n} - {{R}^{′}}_{i n}}{{ρ}_{in , k}} \qquad ( 2 )$$

From FIG. 4, the difference between \hat{P} and P′ is of the following form due to the same slope ρ_{out,k}:

$${P}^{̑} - P = \frac{{{R}^{̑}}_{out} - {{R}^{′}}_{out}}{{ρ}_{out , k}} \qquad ( 3 )$$

Substitution equation (2) into equation (3) yields

$$\frac{{{R}^{̑}}_{out} - {{R}^{′}}_{out}}{{ρ}_{out , k}} = \frac{{{R}^{̑}}_{i n} - {{R}^{′}}_{i n}}{{ρ}_{in , k}} \qquad ( 4 )$$

Then, equation (4) leads to

$${{R}^{̑}}_{out} = {{R}^{′}}_{out} + Δ {R}_{out} \qquad ( 5 )$$

where

$$Δ {R}_{out} = \frac{{ρ}_{out , k}}{{ρ}_{i n , k}} \cdot ( {{R}^{̑}}_{i n} - {{R}^{′}}_{i n} ) = {λ}_{k} \cdot ( {{R}^{̑}}_{i n} - {{R}^{′}}_{i n} ) \qquad ( 6 )$$

In equation (6), λₖ denotes the predetermined factor that is defined as the ratio of ρ_{out,k} to ρ_{in,k}. In light of equations (5) and (6), the current output value

$${{R}^{′}}_{out}$$

needs to be adjusted by a quantity equal to ΔRₒᵤₜ thereby causing the currently detected power P′ to approach the desired output power \hat{P}. Furthermore, the predetermined factor λₖ is typically different from channel to channel. Therefore, there is a need to provide a look-up table (LUT) storing a number of predetermined factors for respective channel frequencies. Turning back to FIG. 2, the computing means 240 selects an appropriate predetermined factor from the LUT 242 and applies it to adjust a related channel using equations (5) and (6).

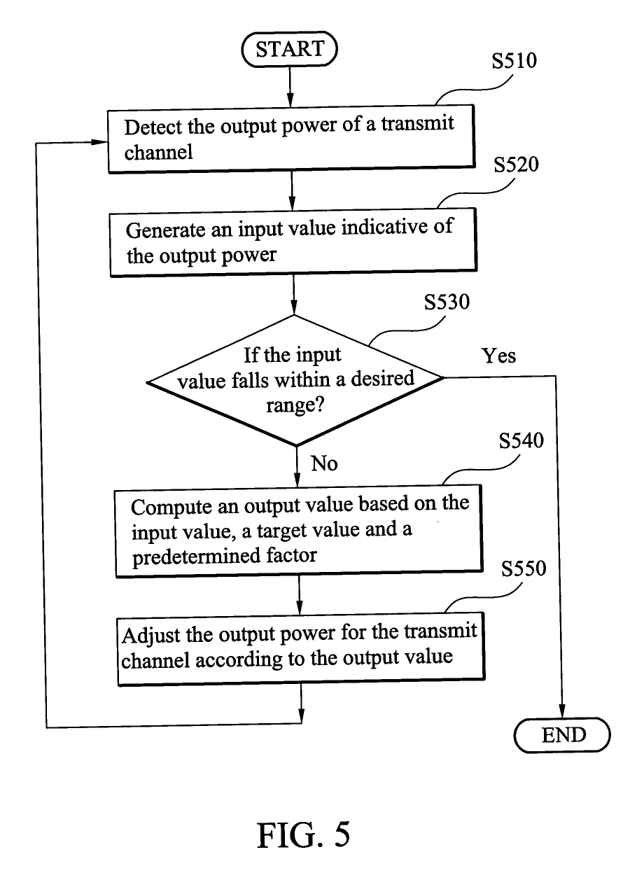

Referring now to FIG. 5, a flowchart of primary steps for transmit power adjustment according to the invention is illustrated. In operation, the output power of a kth transmit channel is detected first (step S510). As mentioned previously, the output power is detected from the power amplifier 260 subsequent to the transceiver 250. Next, the input value R′ᵢₙ substantially indicative of the currently detected output power P′ is generated (step S520). The input value

$${R}_{i n}^{′}$$

is checked to determine if it falls within a desired range of

$${R}_{i n}^{( 1 )} and {R}_{i n}^{( 2 )}$$

(step S530). If not, the output value \hat{R}ₒᵤₜ is computed based on a difference multiplied by the predetermined factor λₖ of the kth transmit channel, where the difference is between the input value R′ᵢₙ and the target value \hat{R}ᵢₙ (step S540). In this regard, the output value \hat{R}ₒᵤₜ is given by equations (5) and (6). Thereafter, the output power is adjusted to reach the desired output power \hat{P} according to the output value \hat{R}ₒᵤₜ (step S550). It should be noted that the output value \hat{R}ₒᵤₜ is applied to the variable gain amplifier 252 of the transceiver 250 and the output of the variable gain amplifier 252 is controlled accordingly. For the kth transmit channel, the above steps are repeated until the input value is within

$${R}_{i n}^{( 1 )} and {R}_{i n}^{( 2 )} .$$

In view of the above, the present invention provides an efficient scheme of transmit power adjustment for WLAN equipment. The scheme of the invention can adjust the output power of WLAN equipment automatically without manual operations. With the help of the invention, it is not necessary to set up and use complicated instruments during mass production, and manufacture time and cost can be reduced accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for transmit power adjustment in radio frequency systems, comprising the steps of:
detecting output power of a transmit channel;
generating an input value substantially indicative of the output power;
determining if the input value falls within a desired range;
computing an output value based on a difference multiplied by a predetermined factor if the input value is out of the desired range, where the difference is between the input value and a target value substantially corresponding to desired output power of the transmit channel;
adjusting the output power for the transmit channel in accordance with the output value; and
repeating the above steps until the input value is within the desired range.

2. The method as recited in claim 1 wherein the predetermined factor is dictated by a ratio between a first slope of the output value versus the output power and a second slope of the input value versus the output power.

3. The method as recited in claim 2 wherein the adjusting step comprises controlling a variable gain amplifier of a transceiver in accordance with the output value.

4. The method as recited in claim 3 wherein the detecting step detects the output power from a power amplifier subsequent to the transceiver.

5. A method for transmit power adjustment in radio frequency systems, comprising the steps of:
detecting output power of a transmit channel;
generating an input value substantially indicative of the output power;
computing an output value based on a difference multiplied by a predetermined factor, where the difference is between the input value and a target value substantially corresponding to desired output power of the transmit channel; and
adjusting the output power for the transmit channel in accordance with the output value.

6. The method as recited in claim 5 wherein the predetermined factor is dictated by a ratio between a first slope of the output value versus the output power and a second slope of the input value versus the output power, in which the output power is in logarithmic scale.

7. The method as recited in claim 6 wherein the adjusting step comprises controlling a variable gain amplifier of a transceiver in accordance with the output value.

8. The method as recited in claim 7 wherein the detecting step detects the output power from a power amplifier subsequent to the transceiver.

9. An apparatus for transmit power adjustment in radio frequency systems, comprising:
a detector adapted to detect output power of a transmit channel;
an input module coupled to the detector, for generating an input value substantially indicative of the output power;
an output module for accepting an output value that is used to adjust the output power; and
means for computing the output value based on a difference multiplied by a predetermined factor, where the difference is between the input value and a target value substantially corresponding to desired output power of the transmit channel.

10. The apparatus as recited in claim 9 wherein the predetermined factor is dictated by a ratio between a first slope of the output value versus the output power and a second slope of the input value versus the output power.

11. The apparatus as recited in claim 9 wherein the computing means comprises a look-up table storing a plurality of predetermined factors for respective channel frequencies.

12. The apparatus as recited in claim 10 further comprising:
a power amplifier; and
a transceiver coupled between the output module and the power amplifier, having a variable gain amplifier responsive to the output value;
wherein the detector is adapted to detect the output power from the power amplifier.

13. The apparatus as recited in claim 12 wherein the output power emitted from the power amplifier varies substantially linearly with the output value for the transceiver, in which the output power is in logarithmic scale.

14. The apparatus as recited in claim 13 wherein the input value varies substantially linearly with the output power detected by the detector, in which the output power is in logarithmic scale.
